(19) United States
(12) Patent Application Publication
(10) Pub. No.: US 2024/0012242 A1
(43) Pub. Date: Jan. 11, 2024

(54) Methods and Apparatuses for Providing a Single Grating Layer Color Holographic Waveguide Display

(71) Applicant: DigiLens Inc., Sunnyvale, CA (US)

(72) Inventors: Jonathan David Waldern, Los Altos Hills, CA (US); Alastair John Grant, San Jose, CA (US); Sihui He, Sunnyvale, CA (US); Milan Momcilo Popovich, Leicester (GB)

(73) Assignee: DigiLens Inc., Sunnyvale, CA (US)

(21) Appl. No.: 18/330,256

(22) Filed: Jun. 6, 2023

Related U.S. Application Data
(63) Continuation of application No. 16/709,517, filed on Dec. 10, 2019, now abandoned.
(60) Provisional application No. 62/778,239, filed on Dec. 11, 2018.

(51) Int. Cl. G02B 27/01; G02B 27/00; G02B 6/34

(52) U.S. Cl. CPC G02B 27/0103; G02B 27/0081; G02B 6/34; G02B 27/017; G02B 2006/12116

(57) ABSTRACT

A waveguide display comprises: a waveguide supporting a single grating layer; a source of data-modulated light; a first input coupler for directing a first spectral band of light from the source into a first waveguide pupil; a second input coupler for directing a second spectral band of light from the source into a second waveguide pupil; an output coupler comprising multiplexed first and second gratings, at least one fold grating for directing the first spectral band along a first path from the first pupil to the output coupler and providing a first beam expansion; at least one fold grating for directing the second spectral band along a second path from the second pupil to the output coupler and providing a first beam expansion. The first multiplexed grating directing the first spectral band out of the waveguide in a first direction with beam expansion orthogonal to the first beam expansion. The second multiplexed grating directing the second spectral band out of the waveguide in the first direction with beam expansion orthogonal to the first beam expansion.

### CROSS-REFERENCED APPLICATIONS

The present application is a continuation of U.S. patent application Ser. No. 16/709,517, filed on Dec. 10, 2019, which claims priority to U.S. Provisional Patent Application No. 62/778,239, filed on Dec. 11, 2018, the disclosures of which is incorporated herein by reference in their entirety.

### FIELD OF THE INVENTION

The present invention generally relates to waveguide devices and, more specifically, to color holographic waveguide displays.

### BACKGROUND

Waveguides can be referred to as structures with the capability of confining and guiding waves (i.e., restricting the spatial region in which waves can propagate). One class of waveguides includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (“TIR”).

Fabrication of waveguides can include the use of material systems that allow for the recording of holographic optical elements within the waveguides. One class of such material includes polymer dispersed liquid crystal (“PDLC”) mixtures, which are mixtures containing photopolymerizable monomers and liquid crystals. A further subclass of such mixtures includes holographic polymer dispersed liquid crystal (“HPDLC”) mixtures. Holographic optical elements, such as volume phase gratings, can be recorded in such a liquid mixture by illuminating the material with two mutually coherent laser beams. During the recording process, the monomers polymerize and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for Augmented Reality (“AR”) and Virtual Reality (“VR”), compact Heads Up Displays (“HUDs”) for aviation and road transport, and sensors for biometric and laser radar (“LIDAR”) applications.

### SUMMARY OF THE INVENTION

Many embodiments are directed to waveguide displays configured to implement full color displays capable of providing two-dimensional beam expansion and light extraction. For example, many embodiments are directed to a waveguide display that has various components including; a waveguide that supports a single grating layer; a source of data-modulated light optically coupled to said waveguide; a first input coupler for directing a first spectral band of light from said source into a first waveguide pupil; a second input coupler for directing a second spectral band of light from said source into a second waveguide pupil; and an output coupler comprising multiplexed first and second gratings. Additionally, many embodiments include at least one fold grating for directing the first spectral band along a first path from the first pupil to the output coupler which provides a first beam expansion. A least one fold grating can be used for directing the second spectral band along a second path from the second pupil to the output coupler and providing a first beam expansion. The first multiplexed grating can direct the first spectral band out of the waveguide in a first direction with beam expansion orthogonal to the first beam expansion. The second multiplexed grating can direct the second spectral band out of the waveguide in the first direction with beam expansion orthogonal to the first beam expansion.

In other embodiments, the first and second input couplers each comprise at least one of a prism and a grating.

In still other embodiments, the first input coupler comprises a first prism and said second input coupler comprises a second prism, wherein said first and second prisms are disposed along the general light propagation direction of said waveguide.

In yet other embodiments, the first input coupler comprises a first prism and said second light input coupler comprises a second prism, wherein said first and second prisms are disposed along a direction orthogonal to the general light propagation direction of said waveguide.

In still yet other embodiments, the first input coupler comprises a first grating and said second input coupler comprises a second grating, wherein said first and second gratings are disposed along the general light propagation direction of said waveguide.

In other embodiments, the first input coupler comprises a first grating and said second input coupler comprises a second grating, wherein said first and second gratings are disposed along a direction orthogonal to the general light propagation direction of said waveguide.

In still other embodiments, the first input coupler comprises a prism and a first grating and said second input coupler comprises said prism and a second grating, wherein said first and second gratings are disposed along the general light propagation direction of said waveguide.

In yet other embodiments, the first input coupler comprises a prism and a first grating and said second input coupler comprises said prism and a second grating, wherein said first and second gratings are disposed along a direction orthogonal to the general light propagation direction of said waveguide.

In still yet other embodiments, the first input coupler comprises a prism and a first grating and said second input coupler comprises said prism and a second grating, wherein said first and second grating are multiplexed.

In other embodiments, the fold gratings are multiplexed and have prescriptions for performing two-dimensional beam expansion and extraction of light from said waveguide.

In still other embodiments, the fold grating is configured to provide pupil expansion in a first direction, wherein said output grating is configured to provide pupil expansion in a second direction different than said first direction.

In yet other embodiments, the source comprises at least one LED.

In still yet other embodiments, the source comprises at least one LED having a spectral output biased towards a peak wavelength of said first spectral band and at least one LED having a spectral output biased towards a peak wavelength of said second spectral band.

In other embodiments, at least one of said gratings is a rolled k-vector grating.

In still other embodiments, the light undergoes a dual interaction within at least one of said fold gratings.

In yet other embodiments, the source of data modulated light has a microdisplay for displaying image pixels and collimation optics for projecting the image displayed on said microdisplay panel such that each image pixel on said microdisplay is converted into a unique angular direction within said first waveguide.

In still yet other embodiments, at least one grating has spatially varying pitch.

In other embodiments, at least one of the input couplers, the fold grating, and said output grating is one of a switchable Bragg grating recorded in a holographic photopolymer a HPDLC material or a uniform modulation holographic liquid crystal polymer material or a surface relief grating.

In still other embodiments, the first and second input couplers each comprise at least one grating, wherein said at least one grating of each of said first and said input couplers, said fold gratings and said first and second multiplexed are disposed in a single grating layer.

Other embodiments include a method of displaying a color image comprising the steps of:
a) providing a waveguide supporting a single grating layer; a source of light; a first input coupler; a second input coupler; an output coupler comprising multiplexed first and second gratings; a first fold grating; and a second fold grating;
b) directing a first spectral band from said source into a first waveguide pupil via said first input coupler;
c) directing a second spectral band from said source into a second waveguide pupil via said second input coupler;
d) beam-expanding said first spectral band light and redirecting it onto said output coupler by means of said first fold grating
e) beam expanding said second spectral band light and redirecting it onto said output coupler by means of said second fold grating;
f) beam expanding and extracting from waveguide said first spectral band light by means of said first multiplexed grating.
g) beam expanding and extracting from waveguide said second spectral band light by means of said second multiplexed grating

Other embodiments include a waveguide display, with a waveguide supporting a single grating layer. Additionally, the waveguide display may include a source of image-modulated light optically coupled to the waveguide with a first input coupler for directing a first spectral band of light from the source into a first waveguide pupil. The waveguide display may also have a second input coupler for directing a second spectral band of light from the source into a second waveguide pupil. Additionally, a first and second fold gratings for diffracting said first and second spectral bands respectively may be used with an output coupler comprising multiplexed first and second gratings for diffracting the first and second bands respectively out of the waveguide.

Other embodiments include a light field display with a first waveguide display as in in many embodiments and a second waveguide display. The input couplers and output couplers of the first and second waveguides overlap, wherein at least one grating in the first waveguide display has optical power for focusing light extracted from the first waveguide to a first focal plane, wherein at least one grating in said second waveguide display has optical power for focusing light extracted from said first waveguide to a second focal plane, wherein input couplers of the first waveguide display and the second waveguide display each have gratings switchable between diffracting and non-diffracting states.

In yet other embodiments, the gratings of the first waveguide display are in their diffracting states for in-coupling image modulated light for viewing at the first focal plane when gratings of the second waveguide display are in their non diffracting states, wherein gratings of the second waveguide display are in their diffracting states for in-coupling second image modulated light for viewing at the second focal plane when gratings of the first waveguide display are in their non diffracting states.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1 conceptually illustrates a schematic plan view of a waveguide display having a single layer waveguide supporting an input coupler that includes a prism and spatially separated input gratings in accordance with an embodiment of the invention.

FIG. 2 conceptually illustrates a schematic plan view of a waveguide display having a single layer waveguide supporting an input coupler that includes a prism and multiplexed input gratings in accordance with an embodiment of the invention.

FIG. 3 conceptually illustrates a schematic plan view of a waveguide display having a single layer waveguide supporting an input coupler that includes spatially separated input gratings in accordance with an embodiment of the invention.

FIG. 4 conceptually illustrates a schematic plan view of a waveguide display having a single layer waveguide supporting an input coupler that includes multiplexed input gratings in accordance with an embodiment of the invention.

FIGS. 5 and 6 conceptually illustrate schematic plan views of waveguide displays having a single layer waveguide supporting first and second spatially separated input prisms in accordance with various embodiments of the invention.

FIG. 7 conceptually illustrates a schematic plan view of a waveguide display having a waveguide with spatially separated input gratings and multiplexed pairs of gratings combining the dual functions of two-dimensional beam expansion and beam extraction from the waveguide in accordance with an embodiment of the invention.

FIG. 8 conceptually illustrates a flow diagram illustrating a method of providing a color waveguide display with two-dimensional beam expansion using a single grating layer in accordance with an embodiment of the invention.

FIG. 9 conceptually illustrates a schematic cross section view of a light field display having a stack of single layer color waveguides in accordance with an embodiment of the invention.

FIG. 10A conceptually illustrates a schematic cross section view showing a first operational state of a light field display corresponding to the formation of a viewable image at a first range in accordance with an embodiment of the invention.

FIG. 10B conceptually illustrates a schematic cross section view showing a second operational state of a light field display corresponding to the formation of a viewable image at a second range in accordance with an embodiment of the invention.

FIGS. 11A and 11B conceptually illustrate the grating geometry of an exemplary set of gratings in accordance with an embodiment of the invention.

FIGS. 12 and 13 conceptually illustrate a plan view of a waveguide for providing a color image using a single grating layer having an input grating, a fold grating, and an output grating in accordance with an embodiment of the invention.

FIG. 14 conceptually illustrates a cross section view of a dichroic prism system for coupling illumination from red, green, and blue source into a waveguide such that the red-green and green-blue bands of the illumination are spatially sheared on entry into the waveguide in accordance with an embodiment of the invention.

FIG. 15 is a graph illustrating the spectra of two LEDs of similar peak wavelengths used in combination to provide a primary illumination color in accordance with an embodiment of the invention.

FIG. 16 conceptually illustrates a schematic cross section view of a rolled K-vector input grating configured to receive illumination spatially sheared to provide red-green and blue-bands in accordance with an embodiment of the invention.

### DETAILED DESCRIPTION

For the purposes of describing embodiments, some well-known features of optical technology known to those skilled in the art of optical design and visual displays have been omitted or simplified to avoid obscuring the basic principles of the invention. Unless otherwise stated, the term “on-axis” in relation to a ray or a beam direction refers to propagation parallel to an axis normal to the surfaces of the optical components described in relation to the invention. In the following description, the terms light, ray, beam and direction may be used interchangeably and in association with each other to indicate the direction of propagation of light energy along rectilinear trajectories. Parts of the following description will be presented using terminology commonly employed by those skilled in the art of optical design. For illustrative purposes, it is to be understood that the drawings are not drawn to scale unless stated otherwise. For example, the dimensions in certain drawings have been exaggerated.

Turning now to the drawings, color holographic waveguide displays and related methods of manufacturing are illustrated. Waveguide displays can be used in many different applications, including but not limited to HMDs for AR and VR, helmet mounted displays, projection displays, heads up displays (HUDs), Heads Down Displays, (HDDs), autostereoscopic displays, and other 3D displays. Additionally, similar technology can be applied in waveguide sensors such as, for example, eye trackers, fingerprint scanners and LIDAR systems. Waveguide manufacturing, and especially color waveguide manufacturing, can be expensive and prone to low yield due to several factors. One such contributory influence is the difficulty in aligning separate red, green, blue waveguide layers needed in a full color display. This can be mitigated to a significant extent by reducing the number of waveguide layers used to implement full color. For example, a full color waveguide display can be implemented using two waveguide layers, one transmitting blue-green and the other green-red. Ideally, the display should have as low a number of waveguide layers as possible. However, a single configuration of Bragg gratings typically cannot operate efficiently over the full visual spectral bandwidth. Hence, implementing a full color display using a single grating layer can be challenging. As such, many embodiments of the invention are directed towards utilizing different configurations of gratings within a single grating layer to implement full color waveguides capable of providing two-dimensional beam expansion and light extraction.

In many embodiments, a waveguide display is implemented to include a waveguide having a single grating layer. The waveguide display can further include a source of data-modulated light optically coupled to the waveguide, a first input coupler for directing a first spectral band of light from the source into a first waveguide pupil, and a second input coupler for directing a second spectral band of light from the source into a second waveguide pupil. The source of light can include at least one of an LED or a laser. In some embodiments, the source includes separate red, green, and blue emitters. In several embodiments, the waveguide display includes an output coupler having multiplexed first and second gratings, at least one fold grating for directing the first spectral band along a first path from the first pupil to the output coupler, and at least one fold grating for directing the second spectral band along a second path from the second pupil to the output coupler. These fold gratings can be configured to provide a first beam expansion for their respective spectral band. With regards to the output coupler, the first multiplexed grating can be configured to direct the first spectral band out of the waveguide in a first direction with beam expansion orthogonal to the first beam expansion, and the second multiplexed grating can be configured to direct the second spectral band out of the waveguide in the first direction with beam expansion orthogonal to the first beam expansion.

Waveguide displays in accordance with various embodiments of the invention can be implemented and configured in many different ways. In some embodiments, a waveguide display is implemented as a dual-axis beam expansion waveguide that is curved.

Single layer waveguide displays, color waveguide displays, materials, and related methods of manufacturing are discussed below in further detail.

### Waveguide Displays

Waveguide displays in accordance with various embodiments of the invention can be implemented and configured in many different ways. For illustrative and simplification purposes, the general propagation direction discussed throughout this disclosure is from left to right. As can readily be appreciated, waveguide configurations and light propagation directions can be configured accordingly depending on the specific application. The single layer color waveguide architectures described in the present disclosure have several major advantages over multilayer architectures. A first one is that assembly and alignment of multiple layers is not required, leading to improved yield and lower manufacturing cost. A second advantage is reduced fabrication complexity due to only a single layer being required during fabrication using a single exposure process. This leads to a reduction in exposure throughput time and hence reduced cost. The principles of the invention can be applied to a variety of waveguide display and sensor applications, including but not limited to HUDs and HMDs. Although the invention addresses single layer color waveguides, many of the embodiments and teachings disclosed herein can also be applied to monochrome waveguides.

In many embodiments, a waveguide display can include a source of light, input couplers, and output couplers. Input couplers can include at least one of a prism and input grating. In several embodiments, the output couplers are implemented using output gratings. In further embodiments, the waveguide display can include fold gratings. In several embodiments, each of the fold gratings is configured to provide pupil expansion in a first direction and to direct the light to the output grating via total internal reflection, wherein the output grating is configured to provide pupil expansion in a second direction that is different from the first direction, according to the embodiments and teachings disclosed in the cited references. By using the fold grating, the waveguide device advantageously requires fewer layers than previous systems and methods of displaying information according to some embodiments. In addition, by using the fold grating, light can travel by total internal refection within the waveguide in a single rectangular prism defined by the waveguide outer surfaces while achieving dual pupil expansion.

In many embodiments, at least one of the input, fold, or output gratings can combine two or more angular diffraction prescriptions to expand the angular bandwidth. Similarly, in some embodiments at least one of the input, fold, or output gratings can combine two or more spectral diffraction prescriptions to expand the spectral bandwidth. For example, a color multiplexed grating can be used to diffract two or more of the primary colors.

In several embodiments, the grating layer includes a number of pieces including the input coupler, the fold grating, and the output grating (or portions thereof) that are laminated together to form a single substrate waveguide. The pieces can be separated by optical glue or other transparent material of refractive index matching that of the pieces. In some embodiments, the grating layer can be formed via a cell making process by creating cells of the desired grating thickness and vacuum filling each cell with SBG material for each of the input coupler, the fold grating, and the output grating. In many embodiments, the cell is formed by positioning multiple plates of glass with gaps between the plates of glass that define the desired grating thickness for the input coupler, the fold grating, and the output grating. In several embodiments, one cell can be made with multiple apertures such that the separate apertures are filled with different pockets of SBG material. Any intervening spaces can then be separated by a separating material (e.g., glue, oil, etc.) to define separate areas. In some embodiments, the SBG material can be spin-coated onto a substrate and then covered by a second substrate after curing of the material.

In many embodiments directed towards display applications, the fold grating can be oriented (clocked) with its grating vector in a diagonal direction within the waveguide plane. This ensures adequate angular bandwidth for the folded light. However, some embodiments of the invention can utilize other clock angles to satisfy spatial constraints on the positioning of the gratings that can arise in the ergonomic design of the display. The grating vector orientation angle can be referred to as the “clock angle”. In some embodiments, a longitudinal edge of each fold grating is oblique to the axis of alignment of the input coupler such that each fold grating is set on a diagonal with respect to the direction of propagation of the display light. The fold grating is angled such that light from the input coupler is redirected to the output grating. In one example, the fold grating is set at a forty-five-degree angle relative to the direction that the display image is released from the input coupler. This feature can cause the display image propagating down the fold grating to be turned into the output grating. For example, in several embodiments, the fold grating causes the image to be turned 90 degrees into the output grating. In this manner, a single waveguide can provide dual axis pupil expansion in both the horizontal and vertical directions. In a number of embodiments, each of the fold gratings can have a partially diffractive structure. The output grating receives the image light from the fold grating via total internal reflection and provides pupil expansion in a second direction. The output grating can be configured to provide pupil expansion in a second direction different from the first direction and to cause the light to exit the waveguide from the first surface or the second surface.

In many embodiments, the fold grating angular bandwidth can be enhanced by designing the grating prescription to facilitate dual interaction of the guided light with the grating. Exemplary embodiments of dual interaction fold gratings are disclosed in U.S. patent application Ser. No. 14/620,969 entitled “WAVEGUIDE GRATING DEVICE” the disclosure of which is incorporated herein by reference. In some embodiments, waveguides based on the principles discussed above operate in the infrared band. In some embodiments, at least one of the input, fold or output gratings can be based on surface relief structures.

As discussed above, waveguide displays in accordance with various embodiments of the invention can include a source of light. In some embodiments, the source of data modulated light used with the above waveguide embodiments includes an Input Image Node (IIN) incorporating a microdisplay. The input grating can be configured to receive collimated light from the IIN and to cause the light to travel within the waveguide via total internal reflection between the first surface and the second surface to the fold grating. Typically, the IIN integrates in addition to the microdisplay panel, a light source and optical components needed to illuminate the display panel, separate the reflected light, and collimate it into the required FOV. Each image pixel on the microdisplay can be converted into a unique angular direction within the first waveguide. Any of a variety of microdisplay technologies can be utilized. In some embodiments, the microdisplay panel can be a liquid crystal device or a Micro Electro Mechanical System (MEMS) device. In several embodiments, the microdisplay can be based on Organic Light Emitting Diode (OLED) technology. Such emissive devices would typically not require a separate light source and would therefore offer the benefits of a smaller form factor. In a number of embodiments, the IIN can be based on a scanned modulated laser. The IIN projects the image displayed on the microdisplay panel such that each display pixel is converted into a unique angular direction within the substrate waveguide according to some embodiments. The collimation optics contained in the IIN can include lenses and mirrors, which can be diffractive lenses and mirrors. In some embodiments, the IIN can be based on the embodiments and teachings disclosed in U.S. patent application Ser. No. 13/869,866 entitled “HOLOGRAPHIC WIDE ANGLE DISPLAY,” and U.S. patent application Ser. No. 13/844,456 entitled “TRANSPARENT WAVEGUIDE DISPLAY”, the disclosures of which are incorporated herein by reference. In several embodiments, the IIN contains a beamsplitter for directing light onto the microdisplay and transmitting the reflected light towards the waveguide. In a number of embodiments, the beamsplitter is a grating recorded in HPDLC and uses the intrinsic polarization selectivity of such gratings to separate the light illuminating the display and the image modulated light reflected off the display. In some embodiments, the beam splitter is a polarizing beam splitter cube.

In many embodiments, the IIN incorporates a despeckler. Advantageously, the despeckler is holographic waveguide device based on the embodiments and teachings of U.S. Pat. No. 8,565,560 entitled “LASER ILLUMINATION DEVICE”, the disclosure of which is incorporated herein by reference. The light source can be a laser or LED and can include one or more lenses for modifying the illumination beam angular characteristics. The use of a despeckler is particularly important where the source is a laser and the image source is a laser-lit microdisplay or a laser-based emissive display. LED will provide better uniformity than laser. If laser illumination is used, there is a risk of illumination banding occurring at the waveguide output. In some embodiments, laser illumination banding in waveguides can be overcome using the techniques and teachings disclosed in U.S. Provisional Patent Application No. 62/071,277 entitled “METHOD AND APPARATUS FOR GENERATING INPUT IMAGES FOR HOLOGRAPHIC WAVEGUIDE DISPLAYS”, the disclosure of which is incorporated herein by reference. In several embodiments, the light from the light source is polarized. In a number of embodiments, the image source is a liquid crystal display (LCD) micro display or liquid crystal on silicon (LCoS) micro display.

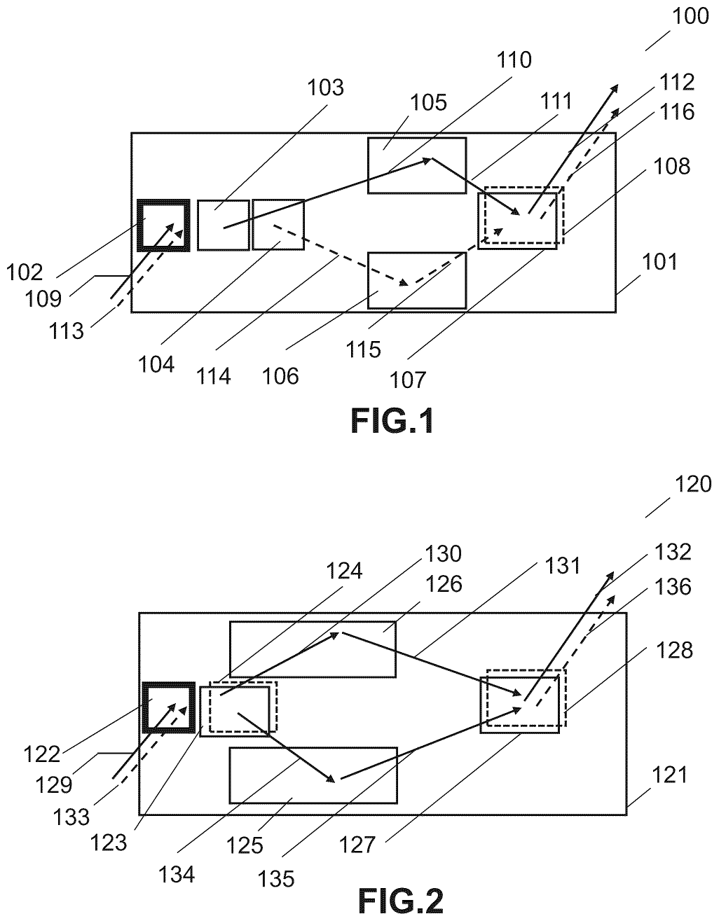

In many embodiments, the waveguide display includes first and second input couplers. The first and second input couplers can each include at least one of a prism and a grating. In some embodiments, the couplers utilize a single prism and are respectively associated with a pair of first and second input gratings, the first and second input gratings being disposed along the general light propagation direction of the waveguide. In several embodiments, the first and second gratings are disposed along a direction orthogonal to the general light propagation direction of the waveguide. The first and second input gratings can be implemented in the waveguide and configured in many different ways. In a number of embodiments, the input gratings are spatially separated. In other embodiments, the input gratings are implemented as multiplexed gratings. The crossed configuration of the multiplexed gratings can be advantageous for gratings recorded in HPDLC materials since it can enable efficient phase separation of liquid crystal and monomer components during the recording of the grating. FIGS. 1 and 2 conceptually illustrate these differences.

FIG. 1 conceptually illustrates a schematic plan view of a waveguide display having a single layer waveguide supporting an input coupler that includes a prism and spatially separated input gratings in accordance with an embodiment of the invention. In the illustrative embodiment, the waveguide display 100 includes a waveguide 101 supporting an input prism 102. The waveguide 101 further includes input gratings 103, 104, fold gratings 105, 106, and multiplexed output gratings 107, 108. As shown, the gratings are disposed in a single grating layer. The beam paths from input to extraction from the waveguide are illustrated by ray paths 109-112 for rays diffracted by input grating 103 and ray paths 113-116 for rays diffracted by input grating 104.

FIG. 2 conceptually illustrates a schematic plan view of a waveguide display having a single layer waveguide supporting an input coupler that includes a prism and multiplexed input gratings in accordance with an embodiment of the invention. As shown, the waveguide display 120 includes a waveguide 121 supporting an input prism 122. The waveguide 121 further includes multiplexed input gratings 123, 124, fold gratings 125, 126, and multiplexed output gratings 127, 128 disposed in a single grating layer. The beam paths from input to extraction from the waveguide are illustrated by ray paths 129-132 for rays diffracted by grating 123 and ray paths 133-136 for rays diffracted by grating 124.

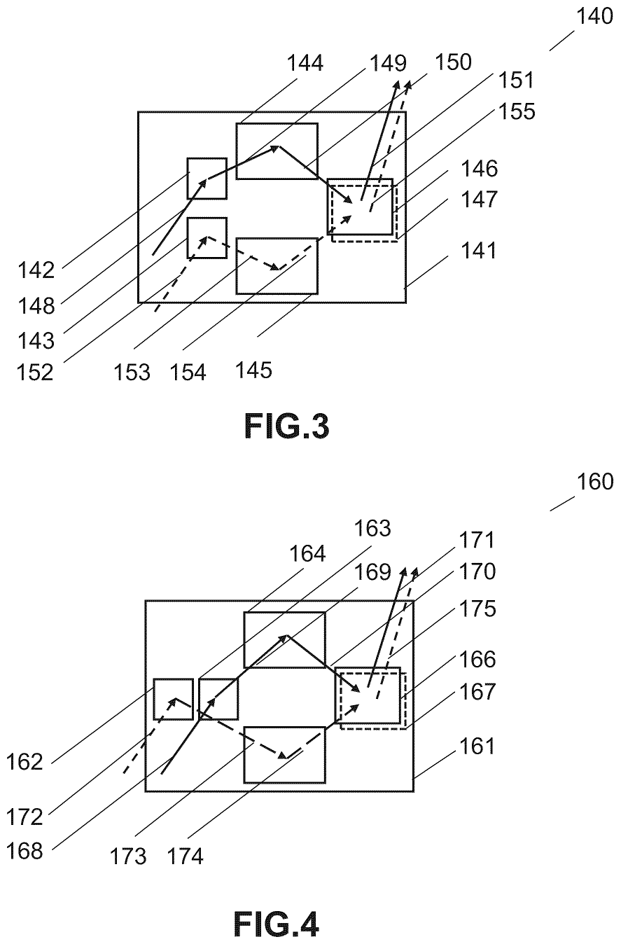

Although FIGS. 1 and 2 illustrate specific waveguide configurations, waveguide displays in accordance with various embodiments of the invention can be implemented in many different ways depending on the specific requirements of a given application. For example, in many embodiments, the first and second input couplers include, respectively, first and second input gratings, and the waveguide display can be implemented without a prism. In further embodiments, the first and second input gratings are disposed along a direction orthogonal to the general light propagation direction of the waveguide. In other embodiments, the first and second input gratings are disposed along the general light propagation direction of the waveguide. FIGS. 3 and 4 conceptually illustrate schematic plan views of waveguide displays implemented with spatially separated input gratings and prism-less input couplers in accordance with various embodiments of the invention. As illustrated, FIG. 3 shows a waveguide display 140 that includes a waveguide 141 supporting input gratings 142, 143 and, layer, fold gratings 144, 145 and multiplexed output gratings 146, 147 all the gratings being disposed in a single layer. The beam paths from input to extraction from the waveguide are illustrated by the ray paths 148-151 in the case of input grating 142 and ray paths 152-155 in the case of input grating 143. Similarly, FIG. 4 shows a waveguide display 160 having a waveguide 161 supporting input gratings 162, 163 and, fold gratings 164, 165 and multiplexed output gratings 166, 167, all the gratings being disposed in a single layer. The beam paths from input to extraction from the waveguide are illustrated by the ray paths 168-171 in the case of input grating 163 and ray paths 172-175 in the case of input grating 162. The key difference between waveguide display 160 and the embodiment shown in FIG. 3 can be distinguished in the arrangement of the input gratings—i.e. FIG. 4 illustrates an embodiment wherein the first and second gratings are disposed along the general light propagation direction of the waveguide. In embodiments such as the ones of FIGS. 3 and 4 and others to be described below, the two spatially separated input couplers can provide two separate input pupils.

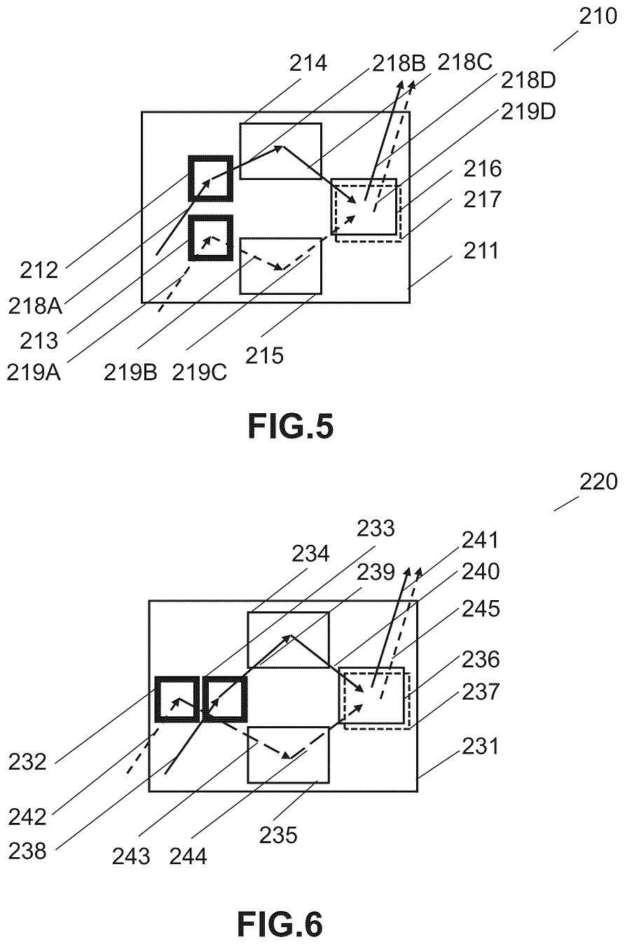

In addition to prism-less input couplers, waveguide displays can implement input couplers that include only prisms. FIGS. 5 and 6 conceptually illustrate schematic plan views of waveguide displays implementing input couplers without input gratings in accordance with various embodiments of the invention. As shown, the first input coupler includes a first prism and the second light input coupler includes a second prism. In FIG. 5, the first and second prisms are disposed along a direction orthogonal to the general light propagation direction of the waveguide. In FIG. 6, the first and second prisms are disposed along the general light propagation direction of the waveguide.

Referring to FIG. 5, the waveguide display 210 includes a waveguide 211 supporting input prisms 212, 213. The waveguide 211 further includes fold gratings 214, 215 and multiplexed output gratings 216, 217 disposed in a single grating layer. The beam paths from input to extraction from the waveguide are illustrated by ray paths 219A-219D for rays coupled into the waveguide by the prism 213 and ray paths 218A-218D for rays coupled into the waveguide by the prism 212. Similarly, FIG. 6 illustrates a waveguide display 220 that includes a waveguide 231 supporting input prisms 232, 233. The waveguide 231 further includes fold gratings 234, 235 and multiplexed output gratings 236, 237 disposed in a single grating layer. The beam paths from input to extraction from the waveguide are illustrated by ray paths 238-241 for rays coupled into the waveguide by the prism 233 and ray paths 242-245 for rays coupled into the waveguide by the prism 222. In embodiments using an input coupler based on only prisms, such as the waveguide displays illustrated in FIGS. 5 and 6, the conditions for grating reciprocity can be addressed using the pitch and clock angles of the fold and output gratings.

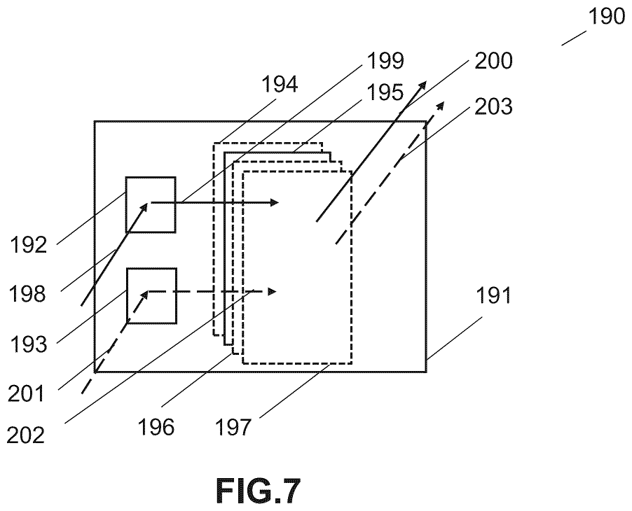

As described in the sections above, the input couplers can be configured in a variety of different ways. Additionally, the fold gratings and output couplers of waveguide displays can also be configured in many different ways. FIG. 7 conceptually illustrates a schematic plan view of a waveguide display having a waveguide with spatially separated input gratings and multiplexed pairs of gratings combining the dual functions of two-dimensional beam expansion and beam extraction from the waveguide in accordance with an embodiment of the invention. As shown, the waveguide display 190 includes a waveguide 191 supporting input coupling prisms 192, 193. The waveguide 191 further includes combined fold and output gratings 194-197 multiplexed. In the illustrative embodiment, the gratings 194, 195 diffract and expand, in two dimensions, the light entering the waveguide 191 via the prism 192. Similarly, the gratings 196, 197 diffract and expand, in two dimensions, the light entering the waveguide 191 via the prism 192, 193. The beam paths from input to extraction from the waveguide are illustrated by ray paths 198-200 in the case of prism 192 and ray paths 201-203 in the case of prism 193. Although four gratings are multiplexed, pairs of gratings corresponding to each of the two paths have Bragg fringes that are crossed. In some embodiments, the input coupling prisms 192, 193 can be replaced by gratings.

In some embodiments directed at displays using unpolarized light sources, the input gratings used can combine gratings orientated such that each grating diffracts a particular polarization of the incident unpolarized light into a waveguide path. Such embodiments may incorporate some of the embodiments and teachings disclosed in the PCT application PCT/GB2017/000040 “METHOD AND APPARATUS FOR PROVIDING A POLARIZATION SELECTIVE HOLOGRAPHIC WAVGUIDE DEVICE” by Waldern et al., the disclosure of which is incorporated herein by reference in its entirety. The output gratings can be configured in a similar fashion such that the light from the waveguide paths is combined and coupled out of the waveguide as unpolarized light. For example, in some embodiments the input grating and output grating each combine crossed gratings with peak diffraction efficiency for orthogonal polarizations states. In several embodiments, the polarization states are S-polarized and P-polarized. In a number of embodiments, the polarization states are opposing senses of circular polarization. The advantage of gratings recorded in liquid crystal polymer systems, such as but not limited to SBGs, in this regard is that owing to their inherent birefringence, they can exhibit strong polarization selectivity. However, other grating technologies that can be configured to provide unique polarization states can also be used.

In embodiments utilizing gratings recorded in liquid crystal polymer material systems, at least one polarization control layer overlapping at least one of the fold gratings, input gratings, or output gratings can be provided for the purposes of compensating for polarization rotation in any of the gratings, particularly the fold gratings. In many embodiments, all of the gratings are overlaid by polarization control layers. In some embodiments, polarization control layers are applied only to a subset of the gratings, such as only to the fold gratings. The polarization control layer can include an optical retarder film. In several embodiments based on HPDLC materials, the birefringence of the gratings can be used to control the polarization properties of the waveguide device. The use of the birefringence tensor of the HPDLC grating, K-vectors, and grating footprints as design variables opens up the design space for optimizing the angular capability and optical efficiency of the waveguide device. In some embodiments, a quarter wave plate disposed on a glass-air interface of the waveguide rotates the polarization of a light ray to maintain efficient coupling with the gratings. For example, in one embodiment, the quarter wave plate is a coating that is applied to a substrate of the waveguide. In some waveguide display embodiments, applying a quarter wave coating to a substrate of the waveguide can help light rays retain alignment with the intended viewing axis by compensating for skew waves in the waveguide. In a number of embodiments, the quarter wave plate can be provided as multi-layer coating.

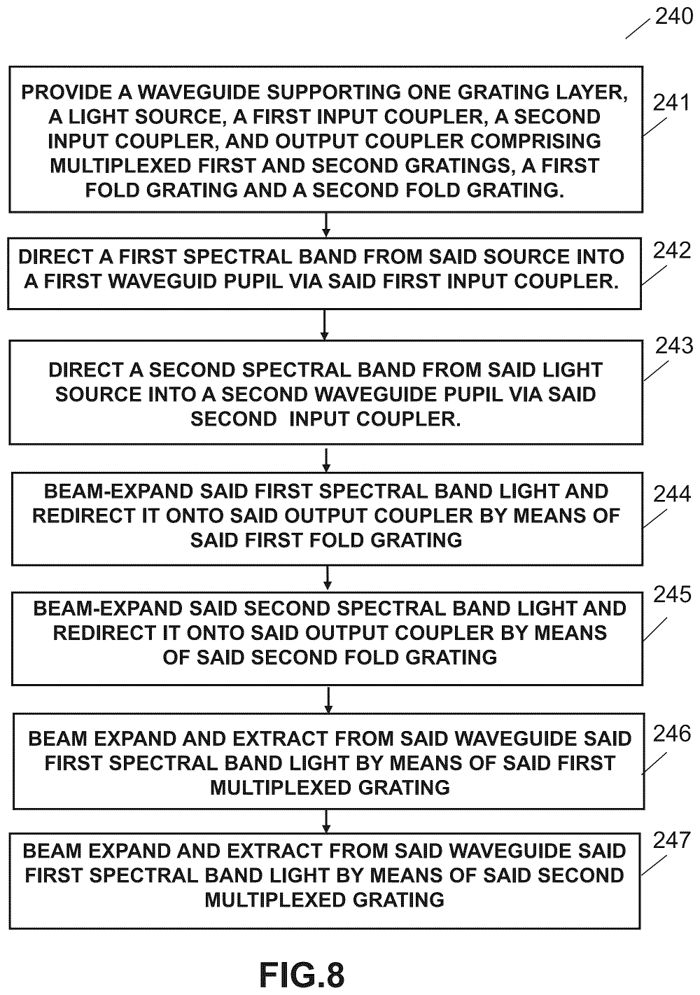

FIG. 8 conceptually illustrates a flow diagram illustrating a method of providing a color waveguide display with two-dimensional beam expansion using a single grating layer in accordance with an embodiment of the invention. As shown, the method 240 of coupling light of more than one polarization component into a waveguide is provided. Referring to the flow diagram, method 240 includes providing (241) a waveguide supporting a single grating layer; a source of light; a first input coupler; a second input coupler; an output coupler having multiplexed first and second gratings; a first fold grating; and a second fold grating. A first spectral band can be directed (242) from the source into a first waveguide pupil via the first input coupler, and a second spectral band can be directed (243) from the source into a second waveguide pupil via the second input coupler. The first spectral band light can be beam-expanded and redirected (244) onto the output coupler by means of the first fold grating. The second spectral band light can be beam-expanded and redirected (245) onto the output coupler by means of the second fold grating. The first spectral band light can be beam-expanded and extracted (246) from waveguide by means of the first multiplexed grating. The second spectral band light can be beam-expanded and extracted (247) from waveguide by means of the second multiplexed grating.

The embodiments discussed above and illustrated in FIGS. 1-8 are based on the principle of input pupil bifurcation using split pupil input coupling or multiplexed input coupling to provide up and down waveguide paths to the output grating using two spatially separated fold gratings. One challenge in implementing this approach is that having two fold gratings can lead to waveguide size growth, particularly vertically, above the eye center point. Another challenge is manufacturing efficient multiplexed output gratings. As such, a number of embodiments in accordance with the invention are directed towards color waveguides architectures based on a single waveguide layer supporting a single grating layer that do not use the beam bifurcation principle.

In many embodiments, the waveguide display is implemented to provide an image at infinity. In some embodiments, the image can be at some intermediate distance. In several embodiments, the image can be at a distance compatible with the relaxed viewing range of the human eye. For example, many waveguides in accordance with various embodiments of the invention can cover viewing ranges from about 2 meters up to about 10 meters.

In some embodiments, the waveguide provides one layer of a multilayer waveguide architecture encompassing single layer grating waveguides, as described above in relation to the embodiments shown in FIGS. 3, 4, and 7, in which each waveguide provides a full color image at a specified viewing range measured from the eyebox. The viewing range can be determined by the optical power encoded into one or more of the gratings in the waveguide. In several embodiments, the optical power will only be encoded into the multiplexed output gratings in order to create minimal decollimation of the guided light. Techniques for encoding optical power into gratings are known to those skilled in the art. A display providing multiple viewing ranges (or focal planes) can be commonly referred to as a light field display. In many embodiments, the input gratings will be switched into their diffracting states such that only one input grating is in its diffracting state (such that image content is projected to one range only) at any instant. The range for projection can be determined using an eye tracker which tracks both eyes to determine the require viewing range by triangulating the measured left and right eye gaze vectors. The image data, typically provided by a microdisplay, can be updated for each viewing range.

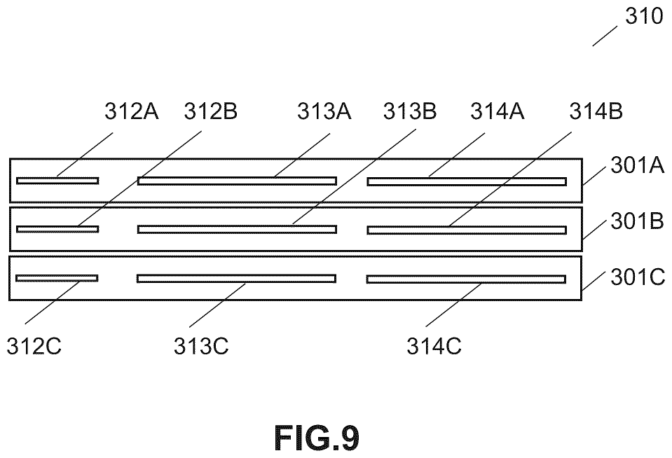

FIG. 9 conceptually illustrates a schematic cross section view of a light field display 310 encompassing a stack of single layer color waveguides 301A-301C in accordance with an embodiment of the invention. In the illustrative embodiment, each waveguide contains input, fold, and multiplexed output gratings labeled by numerals 312, 313, 314 and characters A, B, C respectively according to the waveguide layer. The input gratings of each waveguide may be switchable gratings. In many embodiments, the switchable gratings are SBGs. The input grating shown in FIG. 9 corresponds to one of the two input gratings shown in any one of FIGS. 3-4 and FIG. 7, with both input gratings in each case being switched on simultaneously. At least one grating in a grating layer has optical power for forming a viewable image at a predefined range such that each waveguide provides a unique viewing range.

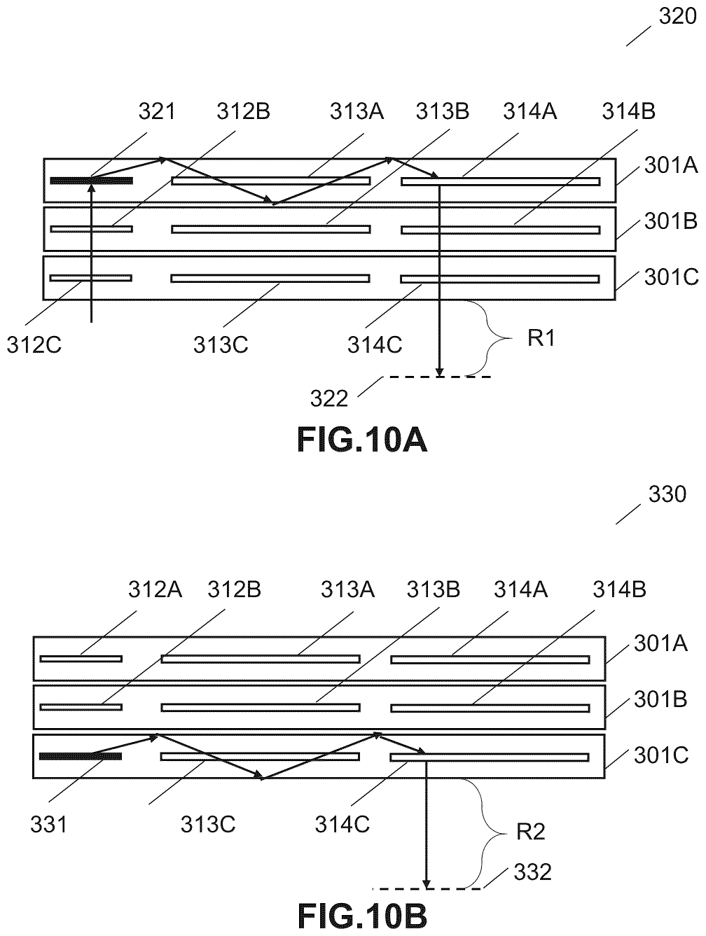

The operation of the light field display is conceptually illustrated in FIGS. 10A and 10B. FIG. 10A is a schematic cross section view showing a first operational state 320 of the waveguide corresponding to the formation of a viewable image 322 at a first range, labelled R1. The input grating 312A, which is shaded in black, is in its diffracting state 321 and the input gratings 312B, 312C are in their non-diffracting state. Hence in the first operational state, light only propagates in waveguide 301A. FIG. 10B is a schematic cross section view showing a second operational state 330 of the waveguide corresponding to the formation of a viewable image 332 at a second range, labelled R2. The input grating 312C, which is shaded in black, is in its diffracting state 331 and the input gratings 312A, 312B are in their non-diffracting state. Hence, in the second operational state, light only propagates in waveguide 301C.

### Switchable Bragg Gratings

Optical structures recorded in waveguides can include many different types of optical elements, such as but not limited to diffraction gratings. In many embodiments, the grating implemented is a Bragg grating (also referred to as a volume grating). Bragg gratings can have high efficiency with little light being diffracted into higher orders. The relative amount of light in the diffracted and zero order can be varied by controlling the refractive index modulation of the grating; a property that is can be used to make lossy waveguide gratings for extracting light over a large pupil. One class of gratings used in holographic waveguide devices is the Switchable Bragg Grating (“SBG”). SBGs can be fabricated by first placing a thin film of a mixture of photopolymerizable monomers and liquid crystal material between glass plates or substrates. In many cases, the glass plates are in a parallel configuration. One or both glass plates can support electrodes, typically transparent tin oxide films, for applying an electric field across the film. The grating structure in an SBG can be recorded in the liquid material (often referred to as the syrup) through photopolymerization-induced phase separation using interferential exposure with a spatially periodic intensity modulation. Factors such as but not limited to control of the irradiation intensity, component volume fractions of the materials in the mixture, and exposure temperature can determine the resulting grating morphology and performance. As can readily be appreciated, a wide variety of materials and mixtures can be used depending on the specific requirements of a given application. In many embodiments, HPDLC material is used. During the recording process, the monomers polymerize and the mixture undergoes a phase separation. The LC molecules aggregate to form discrete or coalesced droplets that are periodically distributed in polymer networks on the scale of optical wavelengths. The alternating liquid crystal-rich and liquid crystal-depleted regions form the fringe planes of the grating, which can produce Bragg diffraction with a strong optical polarization resulting from the orientation ordering of the LC molecules in the droplets. In some embodiments, the grating in a given layer is recorded in stepwise fashion by scanning or stepping the recording laser beams across the grating area. In several embodiments, the gratings are recorded using mastering and contact copying process currently used in the holographic printing industry.

The resulting volume phase grating can exhibit very high diffraction efficiency, which can be controlled by the magnitude of the electric field applied across the film. When an electric field is applied to the grating via transparent electrodes, the natural orientation of the LC droplets can change, causing the refractive index modulation of the fringes to lower and the hologram diffraction efficiency to drop to very low levels. Typically, the electrodes are configured such that the applied electric field will be perpendicular to the substrates. In a number of embodiments, the electrodes are fabricated from indium tin oxide (“ITO”). In the OFF state with no electric field applied, the extraordinary axis of the liquid crystals generally aligns normal to the fringes. The grating thus exhibits high refractive index modulation and high diffraction efficiency for P-polarized light. When an electric field is applied to the HPDLC, the grating switches to the ON state wherein the extraordinary axes of the liquid crystal molecules align parallel to the applied field and hence perpendicular to the substrate. In the ON state, the grating exhibits lower refractive index modulation and lower diffraction efficiency for both S- and P-polarized light. Thus, the grating region no longer diffracts light. Each grating region can be divided into a multiplicity of grating elements such as for example a pixel matrix according to the function of the HPDLC device. Typically, the electrode on one substrate surface is uniform and continuous, while electrodes on the opposing substrate surface are patterned in accordance to the multiplicity of selectively switchable grating elements.

Typically, the SBG elements are switched clear in 30 μs with a longer relaxation time to switch ON. Note that the diffraction efficiency of the device can be adjusted, by means of the applied voltage, over a continuous range. In many cases, the device exhibits near 100% efficiency with no voltage applied and essentially zero efficiency with a sufficiently high voltage applied. In certain types of HPDLC devices, magnetic fields can be used to control the LC orientation. In some HPDLC applications, phase separation of the LC material from the polymer can be accomplished to such a degree that no discernible droplet structure results. An SBG can also be used as a passive grating. In this mode, its chief benefit is a uniquely high refractive index modulation. SBGs can be used to provide transmission or reflection gratings for free space applications. SBGs can be implemented as waveguide devices in which the HPDLC forms either the waveguide core or an evanescently coupled layer in proximity to the waveguide. The glass plates used to form the HPDLC cell provide a total internal reflection (“TIR”) light guiding structure. Light can be coupled out of the SBG when the switchable grating diffracts the light at an angle beyond the TIR condition.

In many embodiments, SBGs are recorded in a uniform modulation material, such as POLICRYPS or POLIPHEM having a matrix of solid liquid crystals dispersed in a liquid polymer. Exemplary uniform modulation liquid crystal-polymer material systems are disclosed in United State Patent Application Publication No.: US2007/0019152 by Caputo et al and PCT Application No.: PCT/EP2005/006950 by Stumpe et al. both of which are incorporated herein by reference in their entireties. Uniform modulation gratings are characterized by high refractive index modulation (and hence high diffraction efficiency) and low scatter. In some embodiments, at least one of the gratings is recorded a reverse mode HPDLC material. Reverse mode HPDLC differs from conventional HPDLC in that the grating is passive when no electric field is applied and becomes diffractive in the presence of an electric field. The reverse mode HPDLC may be based on any of the recipes and processes disclosed in PCT Application No.: PCT/GB2012/000680, entitled IMPROVEMENTS TO HOLOGRAPHIC POLYMER DISPERSED LIQUID CRYSTAL MATERIALS AND DEVICES, the disclosure of which is incorporated herein by reference. Optical recording material systems are discussed below in further detail.

### Grating Structures and Configurations

Each grating within a waveguide can be characterized by a grating vector (or K-vector) in 3D space, which in the case of a Bragg grating is defined as the vector normal to the Bragg fringes. The grating vector can determine the optical efficiency for a given range of input and diffracted angles. The gratings described throughout this disclosure can be implemented in any of a number of different grating configurations. For example, the input and output gratings of some embodiments can be designed to have a common surface grating pitch.

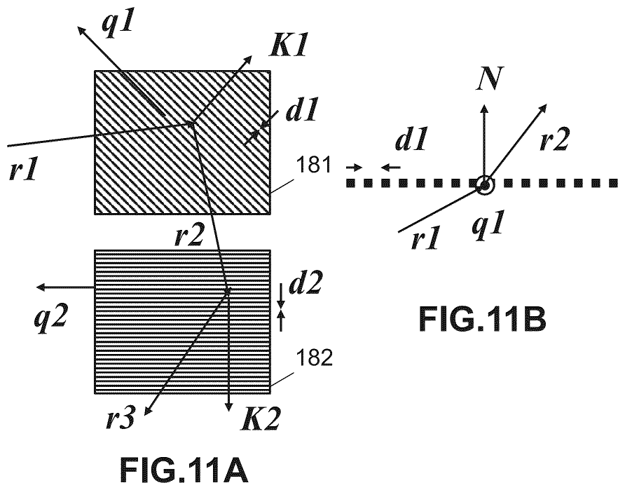

FIGS. 11A and 11B conceptually illustrate the grating geometry of an exemplary set of gratings in accordance with an embodiment of the invention. The vector N is the grating surface normal unit vector; r₁-r₃ are incident and diffracted unit ray vectors; K₁, K₂ are the grating K-vectors (not necessarily in the plane of the drawing); q₁, q₂ are unit vectors parallel to holographic fringe (defining the grating clock angle); d₁, d₂ are grating pitches; and λₐ, λ_{b} are wavelengths. The reciprocity condition for the ray path defined by rays r₁-r₃ can be obtained by applying the grating equation first to the fold grating: r₁×N−r₂×N=λₐ(q₁/d₁) and then to the output grating: r₂×N−r₃×N=λ_{b}(q₂/d₂), which results in the relation q1.z/d1=q2.z/d2 obtained by taking the vector dot products of the vectors q1 and z, where z is a unit vector along a principal waveguide dimension, typically parallel to the average beam propagation direction in the waveguide. The q-vectors are perpendicular to the drawing plane.

In many embodiments, the fold grating and output grating functions are combined in two overlapping multiplexed fold gratings that have opposing clock angles. In some embodiments, the opposing clock angle have different magnitudes. The crossed fold gratings can be configured to perform two-dimensional beam expansion and the extraction of light from the waveguide. Separate pairs of gratings can be provided for each of a first and second path. Hence, many embodiments include a total of four fold gratings that are multiplexed into a single waveguide layer. By combining the fold and output gratings, a substantial reduction in grating real estate can be achieved.

In many embodiments, the waveguide includes at least one grating with a spatially-varying pitch. In some embodiments, each grating has a fixed K vector. In several embodiments, at least one of the gratings is a rolled k-vector grating. Rolling the K-vectors can allow the angular bandwidth of the grating to be expanded without the need to increase the waveguide thickness. In a number of embodiments, a rolled K-vector grating includes a waveguide portion containing discrete grating elements having differently aligned K-vectors. In some embodiments, a rolled K-vector grating includes a waveguide portion containing a single grating element within which the K-vectors undergo a smooth monotonic variation in direction. Various configurations of rolled K-vector gratings, such as but not limited to the ones described above, can be used to input light into the waveguide. The use of a prism to couple light into a waveguide has the advantage of avoiding the significant light loss and restricted angular bandwidth resulting from the use of a rolled K-vector grating. A practical rolled K-vector input grating typically cannot match the much large angular bandwidth of the fold grating, which can be 40 degrees or more.

Although the drawings indicate a high degree of symmetry in the grating geometry and layout of the gratings in the different wavelength channels, in practice the grating prescriptions and footprints can be asymmetric due to different spectral bandwidths. Although the gratings in the upper and lower portions of the waveguide are illustrated with similar areas, the two spectral bands can require that grating prescriptions (including pitch, slant angle and clock angle) be adjusted to balance the two optical paths. Symmetric prism arrangements, that is with prisms arranged along a direction orthogonal to the general beam propagation direction, are likely to be easier to design than in-line arrangements, that is with prisms arrange along the general beam propagation direction. The optimal solution can require consideration of optical efficiency, form factor, and cost. The shapes of the input, fold, or output gratings can depend on the waveguide application and could be of any polygonal geometry subject to factors such as but not limited to the required beam expansion, output beam geometry, beam uniformity, and ergonomic factors.

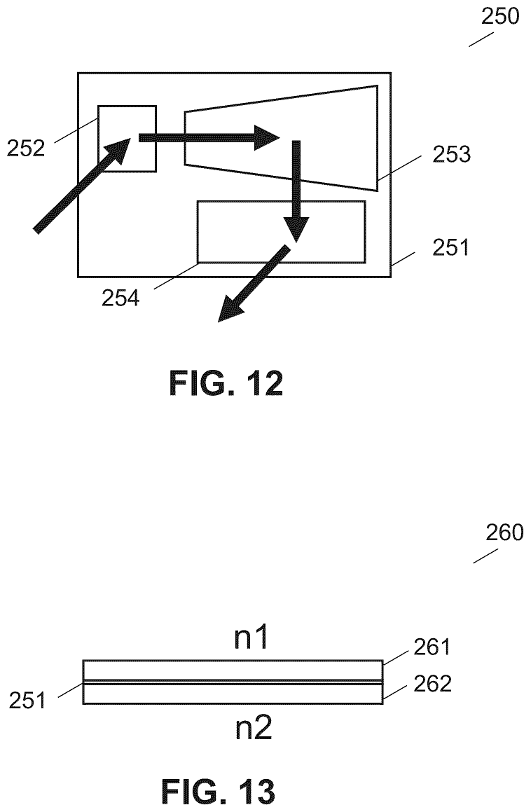

FIG. 12 conceptually illustrates a schematic plan view of a waveguide 250 supporting a single grating layer 251 having one input grating 252 with rolled K-vectors, one fold grating 253, and one output grating 254. In some embodiments, one or both of the fold grating and the output grating can have rolled K-vectors. Referring to FIG. 13, which shows a cross section 260 of the waveguide, the grating layer 251 is shown to be sandwiched by substrates 261, 262 having different indices n1, n2. Operation over the visible band can be achieved by choosing suitable indices n1, n2 and optimizing the rolled K-vector prescriptions of the input grating to provide high diffraction efficiency over the visual band. In several embodiments, the rolled K-vector prescriptions of the output grating can also be adjusted as part of the optimization over the visible band. Further details of embodiments based on FIGS. 12 and 13 are provided in the following paragraphs and accompanying drawings. It should be noted that many of the features of this approach can also be relevant to single layer color waveguides based on beam bifurcation principles.

In many embodiments, the substrate indices are approximately n1=1.5 and n2=1.7. The substrates can be glass or plastic. Having different indices can promote more bounces in the waveguide for higher angles in TIR (fewer interactions than lower angles nearer TIR). The use of substrates of different indices can also promote uniformity of the illumination output from the waveguide. In some embodiments, the use of a high index material (typically of index 1.7 or higher) for one of the substrates supports higher angular carrying capacity of waveguide. In several embodiments where the higher glass index has greater refractive index than the average index of the HPDLC-formed grating, the grating material can set the limit on the angular carrying capacity limits of the waveguide. In a number of embodiments, the upper refractive index is set a little higher than the average level of the grating material. It should be noted that in such embodiments, the purpose of achieving a high waveguide angular carrying capacity is not to extend the field of view, but rather to extend the spectral range that a single waveguide can carry. This is because the dispersion of the broader spectral band from red to blue creates a wider angular range in the waveguide.

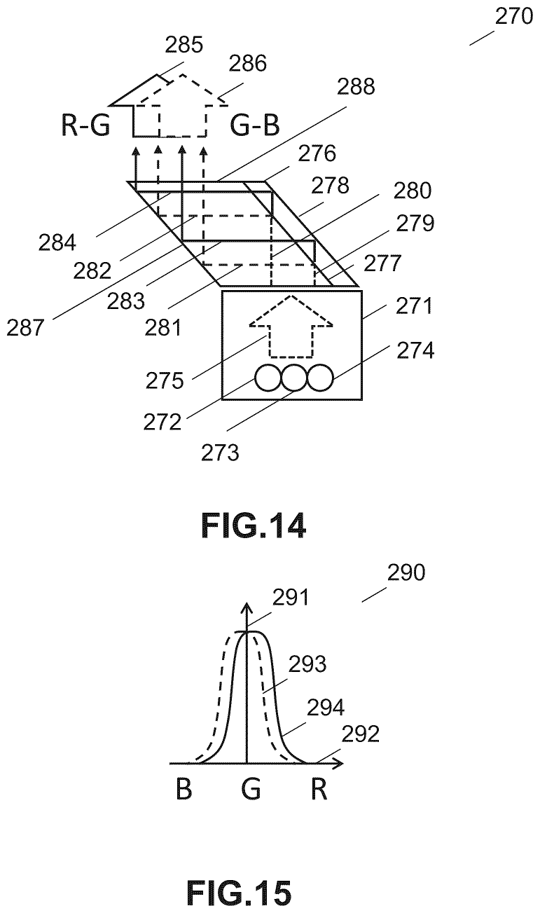

In many embodiments, the rolled K-vector prescription needed to achieve a color single layer grating can be achieved by optimizing the spatial position of the rolled K-vector input grating to match the red-green and green-blue bands of the input illumination by shearing the input pupil via a dichroic prism arrangement. FIG. 14 shows one such arrangement 270 for shearing illumination from RGB sources into relatively displaced red-green and green-blue bands using a prismatic element that includes a reflection surface for reflecting long-wavelengths and a dichroic coating for partially reflecting short wavelengths and transmitting long wavelengths. As shown in FIG. 14, the apparatus 270 includes an illumination module 271 containing red, green and blue light sources 272-274 emitting light in the general direction indicated by block arrow 275. In the illustrative embodiment, the illumination module 271 is optically coupled to a prism system that includes a prism 276 having an internal surface 277 to which a dichroic coating is applied for reflecting short wavelength light and transmitting long wavelength light. The prism face 278 in proximity and parallel to the internal surface can reflect the long wavelength light into the prism. The opposing prism surface 287 can reflect the short wavelength and long wavelength light out of the prism via the face 288 to provide the output beams indicated by block arrows 285, 286. The ray paths for light reflected from the dichroic coating are represented by rays 280, 281, 282. The ray paths for rays reflected by the surface 278 are represented by rays 279, 283, 284. In some embodiments, the source includes at least one LED having a spectral output biased towards a peak wavelength of the first shorter wavelength band and at least one LED having a spectral output biased towards a peak wavelength of the longer wavelength band. In many embodiments, the long wavelength band corresponds to light extending over the green to red region of the visible spectrum, and the short wavelength corresponds to the blue to green region. In other embodiments, the long wavelength band corresponds to red light, and the short wavelength band to light extending over the blue to green region. It should be apparent from consideration of FIG. 14 that other prism configurations can be used to achieve the separation of light into two sheared spectral bands or arbitrarily-defined spectral bandwidth. In some embodiments, the apparatus of FIG. 14 can also employ mirror coatings, polarizers, and/or spectral filtering coatings to provide greater discrimination of the output spectral bands, for example, to reduce crosstalk between the spectral bands. In some embodiments, the color rendition of the waveguide can be improved by using two or more LEDs with spectra relatively displaced by a small amount to provide a required primary color. FIG. 15 conceptually illustrates a graph 290 showing LED output spectra for two such LEDs where the vertical axis labelled 291 corresponds to output intensity and the horizontal axis 292 represents wavelength. The LEDs in this case have peak output in the green (G) band with one LED having spectrum 293 biased toward blue (B) and the other LED having a spectrum 294 biased towards red (R).

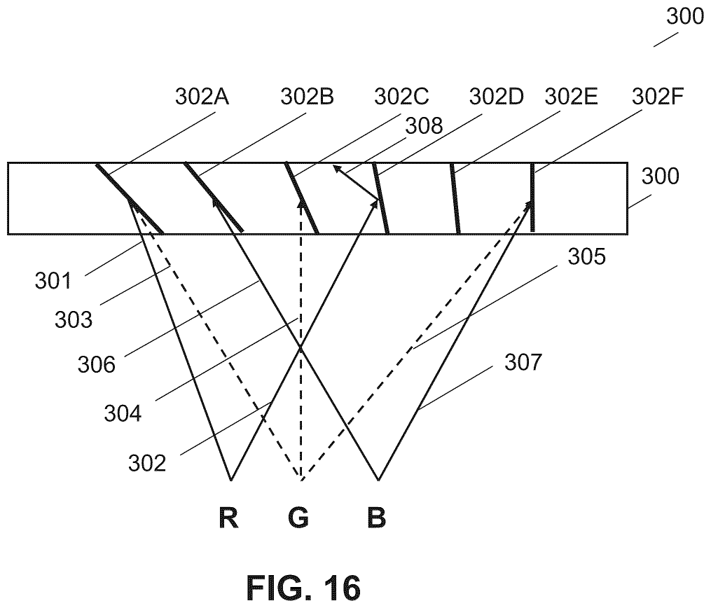

FIG. 16 conceptually illustrates a schematic cross-sectional view 300 showing a portion of a rolled K-vector input grating illuminated by spectrally-sheared illumination across the visible band. The grating includes Bragg fringes 302A-302F which have continuously decreasing slant angles from left to right. Incident light is represented by the effective red, green, and blue sources labelled by R, G, and B, which emit rays labelled by numerals 301-307. A typical diffracted ray that will undergo TIR in the waveguide is indicated by 308. Because of the spectral shearing, Bragg fringes on the left side of the grating, such as 302A, diffract red rays 301 and green rays 303. On the other hand, Bragg fringes on the right side of the grating, such as 302F, diffract green rays 305 and blue rays 307. The use of dichroic prism arrangements, such as but not limited to those described in FIG. 14, can create a step function offset of the two spectral bands. Other techniques can be used to provide spectral shearing. In some embodiments, the spectral shearing is performed continuously as a function of wavelength using the dispersive properties of prisms, for example, with a pair of color corrected prisms. The benefits of the spectral shearing technique are not limited to color waveguides as disclosed herein. The technique can also be used to enhance the performance of color waveguides generally or monochromatic waveguides using rolled K-vector gratings illuminated using green LED emitters, which can have spectral bandwidths of 80 nm. or higher. In several embodiments, continuous spectral shearing can be provided by means of a grating.

In many embodiments based on the principles of the system shown in FIG. 14, more dichroic layers can be used for fine-tuning. However, this is likely to complicate prism manufacturing, and one dichroic layer is likely to be sufficient in most cases. In some embodiments, a dichroic prism can be designed to reflect incident light into angles suitable for waveguide propagation. In several embodiments, a dichroic prism can have high transmission in the visible band for high angles of incidence (in air) to support see through for viewing peripheral field view. In a number of embodiments, a dichroic prism can also be configured to achieve angular alignment of the input image projector with the input grating. This feature can be particularly important for raked waveguides, which are waveguides having a surface normal at an angle to the field of view principal axis.

In many embodiments, a waveguide according to the principles of FIGS. 12 and 13 can operate over the spectral range from approximately 460 nm. to 640 nm. In some embodiments, the source is an LED. In other embodiments, a laser is used. In several embodiments, the light from the source is modulated using a DLP pico projector with a pupil size of approximately 4 mm. In a number of embodiments, LCoS or other pico projector could be used. In some embodiments, the waveguide is designed to have a 30-deg rake angle. In several embodiments, the input light is coupled into the waveguide using a prism. In a number of embodiments, the waveguide provides a brightness greater than 1,500 nits at eyebox targeted from a 30-lumen DLP projector. In some embodiments, spatially-varied grating index modulation is used to control the diffraction efficiency of the waveguide enabling greater uniformity of the waveguide output. Methods and systems for spatially-varied grating index modulation are discussed in further detail in U.S. patent application Ser. No. 16/203,071 entitled “Systems and Methods for Manufacturing Waveguide Cells,” the disclosure of which is hereby incorporated by reference in its entirety. Alternatively, the same or similar effect can be achieved by spatially varying the thickness of the grating layer containing the input, fold, and output gratings. Spatially-varying the index modulation has the advantage of enabling a single thickness grating layer. In some embodiments, an LCP layer disposed after the input grating can be used to rotate polarization to minimize input grating reinteraction out-coupling losses. A waveguide of this type would typically have a relatively small field of view compared with multilayer waveguide architectures. In several embodiments, the waveguide supports a resolution of at least nHD (640×360) standard with a FOV of 15 degrees horizontal×15 degrees vertical. In a number of embodiments, the field of view can be improved by tilting the fold grating. In some embodiments, the above field of view is provided with an eyebox of 18 mm horizontal by 14 mm vertical. Advantageously, the grating can be exposed through the low index (or clearer glass) to minimize holographic recording haze. The waveguide index arrangement eye side/non-eye side can be dependent on the RKV exposure design.

In association with the single layer color waveguide embodiments disclosed herein, there is provided a rolled K-vector exposure method for recording rolled K-vector input gratings with high angular bandwidth. The exposure method can incorporate many of the embodiments and teachings disclosed U.S. Provisional Application No. 62/614,932 entitled “METHODS FOR FABRICATING OPTICAL WAVEGUIDES” by Waldern et al., filed on 8 Jan. 2018, the disclosure of which is incorporated herein by reference.

In many embodiments, the master grating used in manufacturing is an amplitude grating. The rolled K-vector recording typically employs cylindrical lens disposed along the exposure beam path. A wider angular bandwidth increase can be achieved by clocking the cylindrical exposure lens with respect to the input grating on the master. In some embodiments, the input grating on the master can be a chirped grating as disclosed in U.S. Provisional Application No. 62/614,932, the disclosure of which is incorporated herein by reference. A chirped grating can be required to overcome the effects of the non-parallel recording beam and the finite thickness between the master and copy gratings. In other words, to ensure a constant surface period in the copy, which can be required to satisfy grating reciprocity in the final waveguide, the master period should change spatially. In many embodiments, using such mastering techniques, the single plane wavefront input beam interacts with a cylindrical lens to provide 1D focus, and then a portion of the light either generates a diffractive beam from the chirped master or passes through (with attenuation) as zero order and preserving the original 1D focus function of the cylindrical lens. In some embodiments, the local rolled K-vector grating angular bandwidth is maximized as a function of position (for example, the height on the input grating structure if the input grating is clocked with respect to the orthogonal field. This will cause the input grating chirp prescription to vary in 2D with respect to the input wavefront from the cylindrical lens.

Advantageously, to improve color uniformity, gratings can be designed using reverse ray tracing from the eye box to the input grating via the output grating and fold grating. This process can allow for the required physical extent of the gratings, in particular the fold grating, to be identified. Unnecessary grating real estate that contributes to haze can be reduced or eliminated. Ray paths are optimized for red, green, and blue, each of which follows slightly different paths because of dispersion effects between the input and output gratings via the fold grating. The design should permit sufficient gap between input and fold and between fold and output to allow for exposure lenses in the rolled K-vector grating exposure apparatus. This is primarily to prevent ideal fold grating aperture size clipping, and hence loss of support of the direct path ray coupling needed to optimize uniformity.

As used in relation to any of the embodiments described herein, the term grating may encompass a grating that includes of a set of gratings. For example, in many embodiments the input grating and output grating each include two or more gratings multiplexed into a single layer. It is well established in the literature of holography that more than one holographic prescription can be recorded into a single holographic layer. Methods for recording such multiplexed holograms are well known to those skilled in the art. In some embodiments, the input grating and output grating can each include two overlapping gratings layers that are in contact or vertically separated by one or more thin optical substrate. In several embodiments, the grating layers are sandwiched between glass or plastic substrates. In a number of embodiments, two or more such gratings layers can form a stack within which total internal reflection occurs at the outer substrate and air interfaces. In some embodiments, the waveguide can include just one grating layer. In several embodiments, electrodes can be applied to faces of the substrates to switch gratings between diffracting and clear states. The stack can further include additional layers such as beam splitting coatings and environmental protection layers.

In many embodiments of the invention directed at displays, a waveguide display can be combined with an eye tracker. In one preferred embodiment the eye tracker is a waveguide device overlaying the display waveguide and is based on the embodiments and teachings of PCT Application No.: GB2014/000197 entitled “HOLOGRAPHIC WAVEGUIDE EYE TRACKER,” PCT Application No.: GB2015/000274 entitled “HOLOGRAPHIC WAVEGUIDE OPTICAL TRACKER,” and PCT Application No.: GB2013/000210 entitled “APPARATUS FOR EYE TRACKING”, the disclosures of which is incorporated herein by reference. Many embodiments of the invention are directed towards waveguide displays that can further include a dynamic focusing element. The dynamic focusing element may be based on the embodiments and teachings of U.S. Provisional Patent Application No. 62/176,572 entitled “ELECTRICALLY FOCUS TUNABLE LENS”, the disclosure of which is incorporated herein by reference. In some embodiments, a waveguide display according to the principles of the invention further includes a dynamic focusing element and an eye tracker to provide a light field display based on the embodiments and teachings disclosed in U.S. Provisional Patent Application No. 62/125,089 entitled “HOLOGRAPHIC WAVEGUIDE LIGHT FIELD DISPLAYS”, the disclosure of which is incorporated herein by reference. Some embodiments of the invention may be directed towards waveguide displays based on some of the embodiments of U.S. patent application Ser. No. 13/869,866 entitled HOLOGRAPHIC WIDE ANGLE DISPLAY, and U.S. patent application Ser. No. 13/844,456 entitled TRANSPARENT WAVEGUIDE DISPLAY, the disclosures of which is incorporated herein by reference. In some embodiments, a waveguide apparatus according to the principles of the invention may be integrated within a window, for example a windscreen-integrated HUD for road vehicle applications. In some embodiments, a window-integrated display may be based on the embodiments and teachings disclosed in United States Provisional Patent Application No.: PCT Application No.: PCT/GB2016/000005 entitled ENVIRONMENTALLY ISOLATED WAVEGUIDE DISPLAY, the disclosure of which is incorporated herein by reference. In some embodiments, a waveguide apparatus may include gradient index (GRIN) wave-guiding components for relaying image content between the IIN and the waveguide. Exemplary embodiments are disclosed in PCT Application No.: PCT/GB2016/000005 entitled ENVIRONMENTALLY ISOLATED WAVEGUIDE DISPLAY, the disclosure of which is incorporated herein by reference. In some embodiments, the waveguide apparatus may incorporate a light pipe for providing beam expansion in one direction based on the embodiments disclosed in U.S. Provisional Patent Application No. 62/177,494 entitled WAVEGUIDE DEVICE INCORPORATING A LIGHT PIPE, the disclosure of which is incorporated herein by reference. Optical devices based on any of the above-described embodiments may be implemented using plastic substrates using the materials and processes disclosed in PCT Application No.: PCT/GB2012/000680, entitled IMPROVEMENTS TO HOLOGRAPHIC POLYMER DISPERSED LIQUID CRYSTAL MATERIALS AND DEVICES, the disclosure of which is incorporated herein by reference.

### HPDLC Material Systems

HPDLC mixtures in accordance with various embodiments of the invention generally include LC, monomers, photoinitiator dyes, and coinitiators. The mixture (often referred to as syrup) frequently also includes a surfactant. For the purposes of describing the invention, a surfactant is defined as any chemical agent that lowers the surface tension of the total liquid mixture. The use of surfactants in HPDLC mixtures is known and dates back to the earliest investigations of HPDLCs. For example, a paper by R. L Sutherland et al., SPIE Vol. 2689, 158-169, 1996, the disclosure of which is incorporated herein by reference, describes a PDLC mixture including a monomer, photoinitiator, coinitiator, chain extender, and LCs to which a surfactant can be added. Surfactants are also mentioned in a paper by Natarajan et al, Journal of Nonlinear Optical Physics and Materials, Vol. 5 No. I 89-98, 1996, the disclosure of which is incorporated herein by reference. Furthermore, U.S. Pat. No. 7,018,563 by Sutherland; et al., discusses polymer-dispersed liquid crystal material for forming a polymer-dispersed liquid crystal optical element comprising: at least one acrylic acid monomer; at least one type of liquid crystal material; a photoinitiator dye; a coinitiator; and a surfactant. The disclosure of U.S. Pat. No. 7,018,563 is hereby incorporated by reference in its entirety.

The patent and scientific literature contains many examples of material systems and processes that can be used to fabricate SBGs, including investigations into formulating such material systems for achieving high diffraction efficiency, fast response time, low drive voltage, and so forth. U.S. Pat. No. 5,942,157 by Sutherland, and U.S. Pat. No. 5,751,452 by Tanaka et al. both describe monomer and liquid crystal material combinations suitable for fabricating SBG devices. Examples of recipes can also be found in papers dating back to the early 1990s. Many of these materials use acrylate monomers, including:
R. L. Sutherland et al., Chem. Mater. 5, 1533 (1993), the disclosure of which is incorporated herein by reference, describes the use of acrylate polymers and surfactants. Specifically, the recipe comprises a crosslinking multifunctional acrylate monomer; a chain extender N-vinyl pyrrolidinone, LC E7, photo-initiator rose Bengal, and coinitiator N-phenyl glycine. Surfactant octanoic acid was added in certain variants.
Fontecchio et al., SID 00 Digest 774-776, 2000, the disclosure of which is incorporated herein by reference, describes a UV curable HPDLC for reflective display applications including a multi-functional acrylate monomer, LC, a photoinitiator, a coinitiators, and a chain terminator.
Y. H. Cho, et al., Polymer International, 48, 1085-1090, 1999, the disclosure of which is incorporated herein by reference, discloses HPDLC recipes including acrylates.
Karasawa et al., Japanese Journal of Applied Physics, Vol. 36, 6388-6392, 1997, the disclosure of which is incorporated herein by reference, describes acrylates of various functional orders.
T. J. Bunning et al., Polymer Science: Part B: Polymer Physics, Vol. 35, 2825-2833, 1997, the disclosure of which is incorporated herein by reference, also describes multifunctional acrylate monomers.
G. S. Iannacchione et al., Europhysics Letters Vol. 36 (6). 425-430, 1996, the disclosure of which is incorporated herein by reference, describes a PDLC mixture including a penta-acrylate monomer, LC, chain extender, coinitiators, and photoinitiator.

Acrylates offer the benefits of fast kinetics, good mixing with other materials, and compatibility with film forming processes. Since acrylates are cross-linked, they tend to be mechanically robust and flexible. For example, urethane acrylates of functionality 2 (di) and 3 (tri) have been used extensively for HPDLC technology. Higher functionality materials such as penta and hex functional stems have also been used.

One of the known attributes of transmission SBGs is that the LC molecules tend to align with an average direction normal to the grating fringe planes (i.e., parallel to the grating or K-vector). The effect of the LC molecule alignment is that transmission SBGs efficiently diffract P polarized light (i.e., light with a polarization vector in the plane of incidence), but have nearly zero diffraction efficiency for S polarized light (i.e., light with the polarization vector normal to the plane of incidence).

### DOCTRINE OF EQUIVALENTS

While the above description contains many specific embodiments of the invention, these should not be construed as limitations on the scope of the invention, but rather as an example of one embodiment thereof. Although only a few embodiments have been described in detail in this disclosure, many modifications are possible (for example, variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A waveguide display, comprising:
a waveguide supporting a single grating layer having a general light propagation direction;
a source of data-modulated light optically coupled to said waveguide;
a first input coupler for directing a first spectral band of light from said source into a first waveguide pupil;
a second input coupler for directing a second spectral band of light from said source into a second waveguide pupil;
an output coupler comprising multiplexed first and second gratings;
a first fold grating for directing said first spectral band along a first path from said first pupil to said output coupler and providing a first beam expansion;
at least a second fold grating for directing said second spectral band along a second path from said second pupil to said output coupler and providing a first beam expansion;
said first multiplexed grating directing said first spectral band out of said waveguide in a first direction with beam expansion orthogonal to said first beam expansion,
said second multiplexed grating directing said second spectral band out of said waveguide in said first direction with beam expansion orthogonal to said first beam expansion.

2. The apparatus of claim 1, wherein said first and second input couplers each comprise at least one of a prism and a grating.

3. The apparatus of claim 1, wherein said first input coupler comprises a first prism and the second input coupler comprises a second prism, wherein the first and second prisms are disposed along the general light propagation direction of the waveguide.

4. The apparatus of claim 1, wherein the first input coupler comprises a first prism and the second light input coupler comprises a second prism, wherein the first and second prisms are disposed along a direction orthogonal to the general light propagation direction of the waveguide.

5. The apparatus of claim 1, wherein the first input coupler comprises a first grating and the second input coupler comprises a second grating, wherein the first and second gratings are disposed along the general light propagation direction of the waveguide.

6. The apparatus of claim 1, wherein the first input coupler comprises a first grating and the second input coupler comprises a second grating, wherein the first and second gratings are disposed along a direction orthogonal to the general light propagation direction of the waveguide.

7. The apparatus of claim 1, wherein the first input coupler comprises a prism and a first grating and the second input coupler comprises the prism and a second grating, wherein the first and second gratings are disposed along the general light propagation direction of the waveguide.

8. The apparatus of claim 1, wherein said first input coupler comprises a prism and a first grating and said second input coupler comprises the prism and a second grating, wherein the first and second gratings are disposed along a direction orthogonal to the general light propagation direction of the waveguide.

9. The apparatus of claim 1, wherein the first input coupler comprises a first prism and a first grating and the second input coupler comprises a second prism and a second grating, wherein the first and second grating are multiplexed.

10. The apparatus of claim 1, wherein the fold gratings are multiplexed and have prescriptions for performing two-dimensional beam expansion and extraction of light from the waveguide.

11. The apparatus of claim 1 wherein each of the first and second fold gratings is configured to provide pupil expansion in a first direction, wherein the output grating is configured to provide pupil expansion in a second direction different from the first direction.

12. The apparatus of claim 1, wherein the source comprises at least one LED.

13. The apparatus of claim 1, wherein the source comprises at least one LED having a spectral output biased towards a peak wavelength of the first spectral band and at least one LED having a spectral output biased towards a peak wavelength of the second spectral band.

14. The apparatus of claim 1 wherein at least one of the gratings is a rolled k-vector grating.

15. The apparatus of claim 1 wherein the light undergoes a dual interaction within at least one of the fold gratings.

16. The apparatus of claim 1, wherein the source of data modulated light comprises:
a microdisplay panel wherein the microdisplay is configured for displaying image pixels; and
an input image node with collimation optics wherein the input image node projects an image displayed on the microdisplay panel such that each image pixel on the microdisplay panel is converted into a unique angular direction within the first waveguide

17. The apparatus of claim 1 comprising at least one grating with spatially varying pitch.

18. The apparatus of claim 1, wherein at least one of the input couplers, the fold grating, and the output grating is one of a switchable Bragg grating recorded in a holographic photopolymer a HPDLC material or a uniform modulation holographic liquid crystal polymer material or a surface relief grating.

19. A method of displaying a color image comprising the steps of:
providing a waveguide supporting a single grating layer, a source of light, a first input coupler, a second input coupler, an output coupler comprising multiplexed first and second gratings, a first fold grating, and a second fold grating;
directing a first spectral band from the source into a first waveguide pupil via the first input coupler;
directing a second spectral band from the source into a second waveguide pupil via the second input coupler;
beam-expanding the first spectral band light and redirecting it onto the output coupler by means of the first fold grating;
beam expanding the second spectral band light and redirecting it onto the output coupler by means of the second fold grating;
beam expanding and extracting from waveguide the first spectral band light by means of the first multiplexed grating; and
beam expanding and extracting from waveguide the second spectral band light by means of the second multiplexed grating.

20. A waveguide display, comprising:
a waveguide supporting a single grating layer;
a source of image-modulated light optically coupled to the waveguide;
a first input coupler for directing a first spectral band of light from the source into a first waveguide pupil;
a second input coupler for directing a second spectral band of light from the source into a second waveguide pupil;
first and second fold gratings for diffracting the first and second spectral bands respectively; and
an output coupler comprising multiplexed first and second gratings for diffracting the first and second bands respectively out of the waveguide.
